(19) United States
(12) Patent Application Publication
(10) Pub. No.: US 2026/0105658 A1
(43) Pub. Date: Apr. 16, 2026

(54) REAL-TIME AUGMENTED REALITY COSMETIC SYSTEMS AND METHODS FOR VIDEO CALLS

(71) Applicant: ELC MANAGEMENT LLC, Melville, NY (US)

(72) Inventor: Christopher Aidan, Austin, TX (US)

(21) Appl. No.: 18/917,402

(22) Filed: Oct. 16, 2024

(51) Int. Cl. G06T 11/60; G06V 10/774; G06V 40/16; H04L 65/80

(52) U.S. Cl. CPC G06T 11/60; G06V 10/774; G06V 40/168; H04L 65/80; G06T 2200/24; G06T 2210/08; G06T 2210/36

(57) ABSTRACT

Systems and methods for dynamically depicting users with virtual cosmetic looks during video calls or video conferences are provided. An example system receives an indication of a virtual cosmetic look. The virtual cosmetic look specifies application locations and techniques of virtual cosmetics associated with at least one facial feature. The system overlays, in a real-time image stream, each virtual cosmetic onto a depiction of the associated facial feature of a user within the real-time image stream, the overlay in accordance with one or more characteristics of the facial feature of the user and with the virtual cosmetic look. The system causes the overlaid real-time image stream to be transmitted, via a communication channel, during a video call. The system modifies the overlaid real-time image stream responsive to changes in one or more characteristics of the communication channel during the video call.

### TECHNICAL FIELD

The present disclosure relates generally to systems and methods for generating virtual cosmetics, and in particular, systems and methods dynamically depicting users with virtual cosmetics during video calls.

### BACKGROUND

In recent years, the growing reliance on digital communication platforms, notably video calling and conferencing, has underscored the importance of personal appearance in virtual interactions. Traditional approaches to enhancing one’s appearance for video conferencing have predominantly involved physical adjustments, such as cosmetic application, external lighting positioning and optimization, and camera positioning. Despite their effectiveness, these methods often require substantial time investment, can yield inconsistent results, and necessitate a collection of physical cosmetic products, which may not always be readily available or suitable for all skin types and tones. Further, such approaches do not account for fluctuations in video call quality and/or user representation due to changes in the communication channel of the video call, such as bandwidth, throughput, connection consistency, etc.

The advent of augmented reality (AR) technology has introduced possibilities for digital face enhancement through model overlays and various AR effects. However, these technologies often lack the sophistication to provide cosmetic looks customized to a user that also adapt to varying communication channel characteristics to maintain a desired appearance.

Given the limitations of both traditional and AR-based methods for appearance enhancement during video calls, opportunities exist for improved systems and methods that address the challenges of appearance customization, realism, and adaptability during video calls.

### SUMMARY

Generally, the systems, methods, and techniques described herein include dynamically depicting users with virtual cosmetics during video calls.

In one embodiment, a system for dynamically depicting a user with virtual cosmetics during a video call is disclosed. The system may include one or more processors; and one or more non-transitory memories coupled to the one or more processors storing computer-executable instructions on the one or more non-transitory memories that, when executed by the one or more processors, may cause the system to: (i) receive, via a user interface, an indication of a virtual cosmetic look, the virtual cosmetic look specifying respective application locations and application techniques of each virtual cosmetic included in a set of virtual cosmetics to generate the virtual cosmetic look, and the each virtual cosmetic of the set of virtual cosmetics associated with at least one facial feature; (ii) overlay, in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look; (iii) cause the overlaid real-time image stream to be transmitted, via a communication channel, during a video call; and (iv) modify the transmitted overlaid real-time image stream responsive to changes in one or more characteristics of the communication channel during the video call.. The system may include additional, less, or alternate functionality, including that discussed elsewhere herein.

In a variation of the embodiment, the set of virtual cosmetics may correspond to the virtual cosmetic look includes multiple virtual cosmetics.

In another variation of the embodiment, the one or more characteristics of the communication channel may include at least one of: a stability of the communication channel, a bandwidth of the communication channel, a speed of the communication channel, an amount of interference on the communication channel, or a latency of the communication channel.

In yet another variation of the embodiment, (i) the changes in the one or more characteristics of the communication channel may include a degradation of a characteristic of the communication channel past a first threshold, and the modification to the transmitted overlaid real-time image stream includes a reduction of a complexity of a representation, within the transmitted overlaid real-time image stream, of respective application locations and/or application techniques of one or more virtual cosmetics included in the set of virtual cosmetics specified by the virtual cosmetic look; or (ii) the changes in the one or more characteristics of the communication channel may include an improvement to the characteristic of the communication channel past a second threshold, and the modification to the transmitted overlaid real-time image stream includes an increase in the complexity of the representation, within the transmitted overlaid real-time image stream, of the respective application locations and/or application techniques of the one or more virtual cosmetics included in the set of virtual cosmetics specified by the virtual cosmetic look..

In still yet another variation of the embodiment, the system may further comprise additional computer-executable instructions that, when executed by the one or more processors, may cause the system to: responsive to a degradation of a characteristic of the communication channel corresponding to a particular threshold, replace a depiction of the user within the real-time image stream with at least one of a static image of the user or an avatar of the user.

In a variation of the embodiment, the system may further comprise additional computer-executable instructions that, when executed by the one or more processors, may cause the system to: modify the overlay corresponding to the virtual cosmetic look and the user responsive to at least one of: movements of the user depicted within the real-time image stream or changes in lighting depicted within the real-time image stream.

In another variation of the embodiment, the one or more characteristics of the at least one facial feature of the user may include at least one of: a type of a facial feature, a color of the facial feature, a skin type of the facial feature, one or more dimensions of the facial feature, or a level of illumination of the facial feature.

In yet another variation of the embodiment, the system may further comprise additional computer-executable instructions that, when executed by the one or more processors, may cause the system to: determine the one or more characteristics of the at least one facial feature of the user based upon one or more of: the real-time image stream, depth sensor data, or facial recognition of the user.

In still yet another variation of the embodiment, the system may further comprise a machine learning model stored on the one or more non-transitory memories, the machine learning model trained using model training data to determine associations between historical characteristics of historical facial features of respective faces of historical users and historical overlays of historical virtual cosmetics on the historical facial features of the respective faces of the historical users corresponding to historical virtual cometic looks; and wherein the system may utilize the machine learning model to overlay the each virtual cosmetic of the set of virtual cosmetics utilized in the virtual cosmetic look onto the associated at least one facial feature of the user depicted in the real-time image stream in accordance with the one or more characteristics of the at least one facial feature of the user and with the virtual cosmetic look.

In a variation of the embodiment, the system may further comprise a virtual look data store, and wherein the virtual cosmetic look is obtained from the virtual look data store.

In another variation of the embodiment, the virtual cosmetic look may be customized for the user based upon preferences of the user.

In another embodiment, a computer-implemented method for dynamically depicting users with virtual cosmetics during video calls is disclosed. The computer-implemented method may include: (i) receiving, by one or more processors via a user interface, an indication of a virtual cosmetic look, the virtual cosmetic look specifying respective application locations and application techniques of each virtual cosmetic included in a set of virtual cosmetics to generate the virtual cosmetic look, and the each virtual cosmetic of the set of virtual cosmetics associated with at least one facial feature; (ii) overlaying, by the one or more processors in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look; (iii) causing, by the one or more processors, the overlaid real-time image stream to be transmitted, via a communication channel, during a video call; and (iv) modifying, by the one or more processors, the transmitted overlaid real-time image stream responsive to changes in one or more characteristics of the communication channel during the video call. The computer-implemented method may include additional, less, or alternate functionality or actions, including those discussed elsewhere herein.

In yet another embodiment, a non-transitory computer readable medium is disclosed having processor-executable instruction stored thereon that, when executed by one or more processors, may cause the one or more processors to at least: (i) receive, via a user interface, an indication of a virtual cosmetic look, the virtual cosmetic look specifying respective application locations and application techniques of each virtual cosmetic included in a set of virtual cosmetics to generate the virtual cosmetic look, and the each virtual cosmetic of the set of virtual cosmetics associated with at least one facial feature; (ii) overlay, in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look; (iii) cause the overlaid real-time image stream to be transmitted, via a communication channel, during a video call; and (iv) modify the transmitted overlaid real-time image stream responsive to changes in one or more characteristics of the communication channel during the video call . The instructions may direct additional, less, or alternate functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems, methods, and techniques disclosed herein. It should be understood that each figure depicts an embodiment of a particular aspect of the disclosed systems, methods, and techniques, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts a block diagram of an example computing environment in which methods and systems for dynamically depicting users with virtual cosmetics during a video call are implemented, according to some embodiments.

FIG. 2 depicts a combined block and logic diagram for training a machine learning model, according to some embodiments.

FIG. 3A depicts an example system for dynamically depicting users with virtual cosmetics during a video call, according to some embodiments.

FIG. 3B depicts an example first user interface to receive the indication of virtual cosmetics from a user, according to some embodiments.

FIG. 3C depicts an example second user interface depicting a user with virtual cosmetics, according to some embodiments.

FIG. 3D depicts an example third user interface dynamically depicting a user with virtual cosmetics during a video call, according to some embodiments

FIG. 3E depicts an example fourth user interface depicting a user with virtual cosmetics during a video call over a degraded communication channel, according to some embodiments.

FIG. 4 depicts a flow diagram of an example computer-implemented method for dynamically depicting users with virtual cosmetics during a video call, according to some embodiments.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### OVERVIEW

An example system may receive, via a user interface, an indication of a virtual cosmetic look specifying respective application locations and application techniques of each virtual cosmetic included in a set of virtual cosmetics to generate the virtual cosmetic look. Each virtual cosmetic may be associated with at least one facial feature. The system may obtain the virtual cosmetic look, obtain characteristics of facial features of the user, and generate a real-time image stream captured via the image sensor including images of at least a portion of a face of a user. The system may overlay, in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look. The system may cause the overlaid real-time image stream to be transmitted, via a communication channel, during a video call or a video conference and may modify the transmitted overlaid real-time image stream responsive to changes in one or more characteristics of the communication channel during the video call or video conference.

Through the innovative use of AR technology, the techniques described herein may provide a transformative approach to the use of virtual cosmetics for enhancing the video calling/conferencing experience for users. The systems and methods allow a user to indicate a virtual cosmetic look, and provide a real-time overlay of virtual cosmetics comprising the virtual cosmetic look onto the user’s face during a video call or conference, and based upon their specific facial characteristics, to provide a realistic depiction of the virtual cosmetic look. Moreover, the overlay can be modified (e.g., automatically modified) in response to changes in characteristics of the communication channel transmitting the video call (e.g., dynamic changes in one or more characteristics of the communication channel).

One of the numerous significant improvements of the disclosed systems and methods include processing efficiency. The techniques may dynamically adapt virtual cosmetic looks to the user’s unique facial features, environmental conditions (e.g., lighting), video call communication channel characteristics (e.g. network conditions) that may be dynamically changing during the course of the video call. Moreover, the systems and methods may intelligently manage computational resources based on the complexity of the virtual cosmetic look, movements of the user, and changing communication channel characteristics, such as offloading AR-tasks to remote computing device having suitable resources to carry out advance overlays and modeling. As such, the disclosed systems and methods may not only enhance the realism, personalization, and consistency of virtual cosmetics on the user over the duration of the video call, but also may optimize processing resources. In at least some embodiments, machine learning (ML) component(s) may learn from user preferences, communication channel characteristics, user interactions, and feedback, to provide a more efficient use of computing resources, a reduction in the computational load, and a consistent appearance of the user during the video call as well as a smoother, more responsive user experience.

Network usage optimization represents another critical advancement. Techniques may dynamically adapt the quality of virtual cosmetics based on real-time changes in the characteristics of the communication channel transmitting the video call. For example, in conditions of limited bandwidth, the system may modify the complexity of the virtual cosmetic look or even substitute the video feed with a pre-selected image. Such actions ensure that the user’s presentation remains professional and uninterrupted (e.g., at least to a standard, level, or degree of consistency specified by the user), and decrease the computing resources required to perform the virtual cosmetic overlays. In another example in which bandwidth availability decreases, the system can simplify the virtual cosmetic look or switch to a default or user-defined look to maintain the continuity of the video call without compromising the user’s appearance. Conversely, when bandwidth availability increases, the system can enhance the complexity of the virtual cosmetic look, ensuring that the user’s appearance is optimized based upon the communication channel characteristics. Significantly, the system’s adaptability to various communication channel characteristics and responsive dynamic adjustment of virtual cosmetic quality ensures that users enjoy a consistent and high-quality virtual cosmetic application appearance regardless of their internet connectivity, while efficiently managing network and communication resources.

The disclosed real-time AR virtual cosmetic systems, methods, and techniques represent a significant advancement in the integration of AR technology and communication channel monitoring by offering improvements in at least processing efficiency, network usage optimization, and adaptability to changing communication channel conditions, to redefine the appearance of virtual cosmetic looks on a user during video calls and/or video conferences.

The present disclosure generally refers to dynamically depicting a user with virtual cosmetics during a video call between a user and other call participant, however, it should be understood that the techniques disclosed herein may be easily applied to video calls having three or more participants, and/or may be easily applied to video streaming or broadcasts (e.g., one-way video streaming and/or broadcasting).

### EXAMPLE COMPUTING ENVIRONMENT

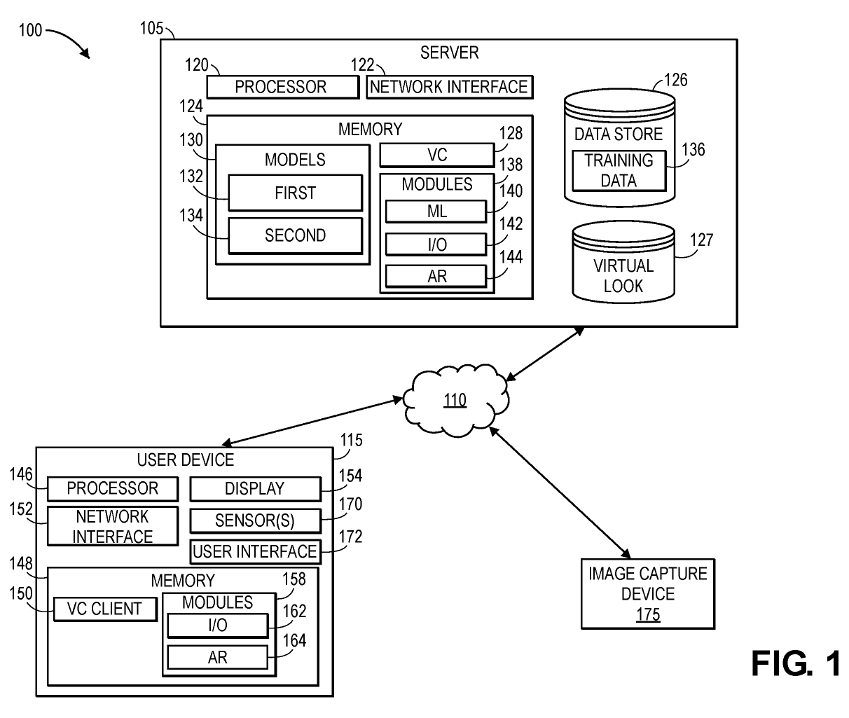

FIG. 1 depicts an example computing environment 100 for dynamically depicting a user with virtual cosmetics during a video call, according to some embodiments. The computing environment 100 may include at least one server 105 communicatively coupled via a network 110 to a user device 115 and an image capture device 175.

The server 105 may be part of a cloud network or may otherwise communicate with other hardware or software components within one or more cloud computing environments to send, retrieve, or otherwise analyze data or information described herein. In some embodiments, the computing environment 100 may comprise an on-premises computing environment, a multi-cloud computing environment, a public cloud computing environment, a private cloud computing environment, and/or a hybrid cloud computing environment. In one example, an entity (e.g., a cosmetics company) may host one or more services in a public cloud computing environment (e.g., Amazon Web Services (AWS), Google Cloud, IBM Cloud, Microsoft Azure, etc.). The public cloud computing environment may be a traditional off-premises cloud (i.e., not physically hosted at a location owned/controlled by the cosmetics company). Alternatively, or in addition, aspects of the public cloud may be hosted on-premises at a location owned/controlled by the entity, e.g., in a private or locally-hosted cloud. The cloud may be partitioned using visualization and multi-tenancy techniques and/or may include one or more of software-as-a-service (SaaS), infrastructure-as-a-service (IaaS) and/or platform-as-a-service (PaaS). In one aspect, the server 105 may include a client-server platform technology such as ASP.NET, Java J2EE, Ruby on Rails, Node.js, a web service or online API, responsive for receiving and responding to electronic requests.

The network 110 may include one or more networks, including a local area network (LAN), wide area network (WAN), the Internet, a combination thereof, and/or any other suitable network. Generally, the network 110 enables bidirectional communication between the server 105, the user device 115, and other components and/or devices of the computing environment 100 (e.g., the image capture device 175). In some embodiments, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally, or alternatively, the network 110 may comprise one or more routers, wireless switches, or other such wireless connection points communicating to the components of the computing environment 100 via wireless communications based upon any one or more of various wireless standards, including by non-limiting example, IEEE 802.11 a/ac/ax/b/c/g/n (Wi-Fi), Bluetooth, and/or the like.

The server 105 may include a processor 120. The processor 120 may include one or more processors, such as one or more central processing units (CPUs), graphics processing units (GPUs), and/or any other suitable processor. The processor 120 may be communicatively coupled to a memory 124 via a computer bus (not depicted) to create, read, update, transmit, delete, or otherwise access or interact with the data, data packets, or otherwise electronic signals to and from the processor 120 and the memory 124, e.g., in order to implement or perform the machine-readable instructions, methods, processes, elements, or limitations, as illustrated, depicted, or described for the various flowcharts, illustrations, diagrams, figures, and/or other disclosure herein. The processor 120 may interface with the memory 124 via a computer bus to execute an operating system and/or computing instructions contained therein, and/or to access other services/aspects. For example, the processor 120 may interface with the memory 124 via the computer bus to create, read, update, delete, or otherwise access or interact with the data stored in the memory 124 and/or the data store 126.

The server 105 may include the network interface 122. The network interface 122 may allow the server 105 to communicate over the network 110 (e.g., with the user device 115, the data store 126) via any suitable wired and/or wireless connection, and/or interface of the network interface 122. The network interface 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the server 105 connected to the network 110.

The server 105 may include at least one processor 120. The processor 120 may include one or more suitable processors (e.g., central processing units (CPUs) and/or graphics processing units (GPUs)). The processor 120 may be communicatively coupled to a memory 124 via a computer bus (not depicted) that transmits electronic data, data packets, or otherwise electronic signals to and from the processor 120 and the memory 124 in order to execute, implement or perform the machine-readable instructions, methods, processes, elements, or limitations, as illustrated, depicted, or described for the various flowcharts, illustrations, diagrams, figures, and/or other disclosure herein. The processor 120 may interface with the memory 124 to execute an operating system, computing instructions contained therein, and/or to access other services/aspects. For example, the processor 120 may interface with the memory 124 via the computer bus to create, read, update, delete, or otherwise access or interact with the data stored in the memory 124, data store 126, and/or another source of data.

The server 105 may include a network interface 122. The network interface 122 may allow the server 105 to communicate over the network 110 via any suitable wired and/or wireless connection, e.g., using any suitable network interface controller(s) of the network interface 122. The network interface 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the server 105 connected to computer network 110.

The memory 124 may include one or more memories of one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 124 may store the operating system (e.g., Microsoft Windows, Linux, UNIX, etc.) capable of facilitating the functionalities, apps, methods, or other software as described herein. The memory 124 may store one or more sets of non-transitory, computer-executable instructions that, when executed, cause the server 105 to perform certain functions.

In general, a computer program or computer-based product, application, or code (e.g., ML models, or other computing instructions described herein) may be stored on a computer usable storage medium, or tangible, non-transitory computer-readable medium (e.g., reference random access memory (RAM), an optical disc, a universal serial bus (USB) drive, or the like) having such computer-readable program code or computer instructions embodied therein. The computer-readable program code or computer instructions may be installed on, or otherwise adapted to be, executed by the processor 120 (e.g., working in connection with the respective operating system in the memory 124) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective C, Java, Scala, ActionScript, JavaScript, HTML, CSS, XML, etc.).

The memory may store a virtual cosmetics application 128. The virtual cosmetics application 128, when executed by the processor 120, may be configured to dynamically depict a user with virtual cosmetics. Features of the virtual cosmetics application 128 may include determining characteristics a user’s facial features, creating, editing, obtaining and/or overlaying virtual cosmetics/virtual cosmetic looks, providing a marketplace for cosmetics and virtual cosmetics, executing one or more of the ML models 130, and/or other suitable features or functionality. In at least some embodiments, the virtual cosmetics application 128 may be accessible to other components, devices, services, etc., of the computing environment 100. For example, the virtual cosmetics application 128 may natively provide real-time video communications (e.g., video calls), may communicate (e.g., via the network 110) with other devices (e.g., the image capture device 175) and/or applications providing the real-time video communication (e.g., as a plug-in or application programming interface (API)), may control the AR module 144 to provide virtual cosmetic overlays, may communicate with the user device 115 to provide the functionality of a virtual cosmetics client application 150 via the virtual cosmetics application 128, etc.

The server 105 may include, or be communicatively coupled to (e.g., via the network 110), at least one electronic data store 126, also referred to herein as a data store. The data store 126 may include a relational database, such as Oracle, DB2, MySQL, a NoSQL database, such as MongoDB, or another electronic database. The database may store data, ML models, ML model training data, etc.

The server 105 may include, or be communicatively coupled to (e.g., via the network 110), a virtual look data store 127. The virtual look data store 127 may store virtual cosmetics, virtual cosmetic looks, user profiles, user preferences, user images, and/or avatar images, among other things. The virtual cosmetics and/or virtual cosmetic looks may be configured for a generic user, and/or for one or more specific users (e.g., virtual cosmetic looks customized to the face of the user). A virtual cosmetic look may include only one virtual cosmetic or multiple virtual cosmetics. Different virtual cosmetic looks may have the same set of virtual cosmetics but may differ in application location and/or application technique of one or more of the virtual cosmetics included in the virtual cosmetic set. In at least some embodiments, the virtual look data store 127 may include user profiles, wherein each user profile may store virtual cosmetics and/or virtual cosmetic looks created by, created for, customed by, and/or customized for the user associated with the user profile.

The data store 126 or other suitable storage (e.g., the memory 124) of the computing environment 100 may store one or more ML models 130, routines, algorithms, or other elements (collectively “models” or “ML models”). The ML models 130 may be, or include, computer-executable instructions that when executed (e.g., by the processor 120 of the server 105, by the user device 115) causing the one or more ML models to receive one or more inputs, and produce or store (e.g., in the memory 124, the data store 126) one or more outputs. Further, the processor 120 should be understood to retrieve/access from the memory 124 and/or the data store 126 any data necessary to perform the executed instructions (e.g., data required as an input to the ML model 130), and to store in the memory 124 and/or the data store 126 the intermediate results and/or output of any executed instructions.

The ML models 130 may include a first ML model 132. The first ML model 132 may be, or include, may be, implement, and/or include, one or more decision trees, random forests, neural networks, and/or any other suitable model. The first ML model 132 may be trained using first model training data to receive the real-time image stream, the characteristics of the one or more facial features of the user, and a virtual cosmetic look including one or more virtual cosmetics for the users, to cause the model to overlay the each virtual cosmetics in real-time onto the associated at least one facial feature of the user in the real-time image stream. The first model training data may include historical characteristics of facial features of historical users, historical virtual cosmetics, historical displays of historical virtual cosmetics and/or historical virtual cosmetic looks on the faces of the historical users (e.g., within video feeds), as well as any other suitable first model training data. The first ML model 132 may be trained using the first model training data to determine associations between the historical characteristics of historical facial features of the faces of the historical users and historical overlays of historical virtual cosmetics associated with the historical facial features on the historical facial features of the faces of the historical users, e.g., via which the historical virtual cosmetic looks were achieved.

The ML models 130 may include a second ML model 134. The second ML model 134 may be, or include, may be, implement, and/or include, one or more decision trees, random forests, neural networks, and/or any other suitable model. The second ML model 134 may be trained using second model training data to receive conditions associated with the communication channel, and predict the change in the communication channel. The conditions may include conditions associated with any stage of the communication channel itself, such as conditions of the communication channel at the service provider (e.g., a telecommunication company, a cable company), conditions of the communication channel between the service provider and the user location (e.g., at a relay station, a base station, a node), conditions of the communication channel at the user location (e.g., residential location, business location), and/or conditions of intermediate transport mechanism or media (e.g., copper fiber, optical fiber, wireless channels, etc.). In one example, the communication channel conditions may include conditions of the network providing the communication channel such as the type of network (e.g., cellular, LAN, coaxial cable, satellite), the bandwidth of the network, the capacity of the network, the status of the network (e.g., online, offline, intermittent interruptions, power levels, signal levels), etc. In another example, the communication channel conditions may include conditions associated with network equipment such as the type of equipment, connected device capacity, speed, bandwidth, latency, signal quality, interference, etc., of routers, wires, switches, couplings, modems, network interfaces, network adapters, etc. In yet another example, the communication channel conditions may include conditions associated with usage of the communication channel such as the time of day and/or the day of the week, the weather conditions during usage, the user location, etc. The communication channel conditions may include any other suitable conditions. The change in the communication channel may include one or more of changes in bandwidth, speed, connectivity, throughput, delay, network availability, latency, etc. The second model training data may include historical conditions associated with historical communication channels and historical changes in the historical communication channels. The second ML model 134 may be trained using the second model training data to determine associations between the historical changes of the historical communication channels and the historical conditions of the historical communication channels (e.g., respective strengths of associations therebetween).

The data store 126 and/or other suitable memory (e.g., the memory 124, the memory of a communicatively coupled computing device) may store one or more sets of training data 136, such as the first model training data and second model training data described. The training data 136 may include testing, validation, feedback, and/or other training data which may be used to create, operate, (re)train and/or fine-tune the ML models 130, such as the first ML model 132 and/or the second ML model 134. The training data 136 may include historical information associated with training one or more of the ML models 130, such as the previously described first model training data and second model training data.

The memory 124 may store one or more computing modules 138, implemented as respective sets of computer-executable instructions (e.g., one or more source code libraries), as described herein. Although FIG. 1 depicts the ML models 130 as part of the memory 124, one or more of the ML models 130 may be considered as a computing module 138, may be stored in the data store 126, may be stored on a device accessible via the network 110, etc.

The computing modules 138 may include an ML module 140. In some embodiments, ML models (e.g., the ML models 130) may be applied by the ML module 140, which may include, but are not limited to linear or logistic regression algorithms, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on server(s) 105. For example, libraries may include the TensorFlow® based library, the Pytorch® library, and/or the scikit-learn® Python library.

In one embodiment, the ML module 140 employs supervised learning, which involves identifying patterns in existing data to make predictions about subsequently received data. Specifically, the ML module 140 is “trained” using training data (e.g., the training data 136), which includes example inputs and associated example outputs. Based upon the training data, the ML module 140 may generate a predictive function which maps outputs to inputs and may utilize the predictive function to generate ML outputs based upon data inputs. The example inputs and example outputs of the training data may include any of the data inputs or ML outputs described herein. In the embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML model outputs.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision making model to generate the ML output based upon the data input, receive a reward signal based upon the reward signal definition and the ML output, and alter the decision making model so as to receive a stronger reward signal for subsequently generated ML outputs. Other types of ML may also be employed, including deep or combined learning techniques.

The ML module 140 may receive labeled data at an input layer of a model having a networked layer architecture (e.g., an artificial neural network, a convolutional neural network, etc.) for training one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models.

The ML module 140 may comprise a set of computer-executable instructions to implement functionality such as loading, configurating, initializing, operating, and/or storing (e.g., in the memory 124, the data store 126) the ML models 130. Once trained, one or more of the trained ML models 130 may be operated in inference mode, whereupon when provided with de novo input that the model has not previously been provided, the model may output one or more predictions, classifications, etc., as described herein.

In operation, the ML module 140 may access the memory 124, the data store 126, and/or any other data source for training data (e.g., training data 136) suitable to generate one or more ML models, such as the ML models 130. The training data 136 may be sample data with assigned relevant and comprehensive labels (classes or tags) used to fit the parameters (weights) of the ML model with the goal of training it by example. In one aspect, once an appropriate ML model is trained and validated to provide accurate predictions and/or responses, the trained ML model may be loaded into the ML module 140 at runtime to process input data and generate output data.

While various embodiments, examples, and/or aspects disclosed herein may include training and generating the ML models 130 for the server 105 to load at runtime, one or more appropriately trained ML models may already exist (e.g., stored in the memory 124, the data store 126) such that the server 105 may load the existing trained ML model 130 at runtime. The server 105 may retrain, fine-tune, update and/or otherwise alter an existing ML model 130 before and/or after loading the ML model 130 at runtime. Although the ML model 130 may be described as being trained and operated (e.g., via ML module 140) on the server 105, in at least one embodiment the ML model 130 may be trained on one server 105 or computing device (e.g., the user device 115), and operated on another server 105 or computing device.

The computing modules 138 may include an input/output (I/O) module 142, comprising a set of computer executable instructions implementing communication functions. The I/O module 142 may include a communication component configured to communicate (e.g., send and receive) data via one or more external/network port(s) to one or more networks or local terminals, such as the network 110 described herein.

The I/O module 142 may further include or implement a user interface configured to present information to an administrator, operator or other user, and/or receive inputs from the user, such as via a touchscreen display. The I/O module 142 may facilitate I/O components (e.g., ports, capacitive or resistive touch sensitive input panels, keys, buttons, lights, LEDs), which may be directly accessible via, or attached to, the server 105 and/or may be indirectly accessible via, or attached to, another device. According to one aspect, a user may access the server 105 via a user interface to input and/or review data/information, initiate ML model training via the ML module 140, and/or perform other functions, such as functions associated with determining one or more reimbursed alignment dates.

The computing modules 138 may include an AR module 144. The AR module 144 may be configured to perform functions associated with generating AR representations, among other things, such as creating virtual cosmetics and/or virtual cosmetic looks (e.g., from the virtual look data store 127), overlaying virtual cosmetics and/or virtual cosmetic looks onto depictions of users (e.g., customizing the virtual cosmetics/virtual cosmetic looks to the specific facial features of the user), dynamically adjusting the virtual cosmetics and/or virtual cosmetic looks (e.g., adjusting dimensions, size, resolution, shading, effects) based upon changes in the depiction of the user in the real-time image stream or changes in the communication channel, and/or other suitable functions. For example, the AR module 144 may customize a virtual cosmetic look comprising virtual lipstick and virtual eyeshadow to the fit the dimensions of the lips and eyelids of the user respectively. The AR module 144 may adjust other qualities and characteristics of the virtual cosmetic look, such as shading and contrast of the virtual cosmetic look, based upon the illumination of the user’s face, the user’s skin tone, the resolution of the virtual cosmetic look based upon the communication channel, etc. The AR module 144 may overlay the virtual cosmetic look onto the depiction of the face of the user in the real-time image stream (e.g., of a video call) Based upon movement of the user’s face in the real-time image stream, the dynamically adjust (e.g., in real-time) the overlay of the virtual lipstick so the virtual lipstick maintains its position on the lips of the user in the real-time image stream as the user’s lips change position, and similarly dynamically adjust the overlay of the virtual eyeshadow so the virtual eyeshadow maintains its position on the eyelids of the user in the real-time image stream as the user’s eyelids change position. The AR module 144 may not only adjust the positioning and overlay of virtual cosmetics on the user’s face in real-time, but may also adjust other qualities of the virtual cosmetics (e.g., brightness, contrast, color, resolution).

The computing environment may include the user device 115. The user device 115 may be, and/or include, a desktop computer, laptop computer, a terminal, a mobile device, a wearable device, augmented, virtual, mixed and/or extended reality glasses/headsets/head-mounted displays (HMD), and/or other suitable computing device(s). The user device 115 may include a processor 146 (e.g., the processor 120) and a memory 148 (e.g., the memory 124) for storing and executing one or more applications, modules, computer-executable instructions, etc. The user device 115 may further include a network interface 152 (e.g., the network interface 122) and a display 154 (e.g., LCD, LED, OLED, HMD, etc.). The user device 115 may access services, devices, and/or components of the computing environment 100 via the network 110. In some embodiments, the user device 115 transmits and/or receives information/data with the server 105 and/or other components of the computing environment 100. For example, the user device 115 may receive a previously-created virtual cosmetic and/or previously-created virtual cosmetic look stored in the virtual look data store 127 from the server 105 via the network 110 so the user may apply the virtual cosmetic look during a video call.

The memory 148 of the user device 115 may store a virtual cosmetics client application 150. The virtual cosmetics client application 150 may be configured to provide the same and/or similar functionality as the virtual cosmetics application 128. The functionality of the virtual cosmetics client application 150 may be provided locally via the virtual cosmetics client application 150, remotely via the virtual cosmetics application 128 of one or more servers 105 communicatively coupled (e.g., via the network 110) to user device 115, via any other suitable device and/or component of the computing environment 100, and/or any combination thereof. For example, the virtual cosmetics client application 150 may be a mobile device application executed locally on the user device 115 and configured to create virtual cosmetic looks and apply the virtual cosmetic look to a static image of the user via the AR module 164. However, the user device 115 and/or AR module 164 may not have the computing resources (e.g., processing capabilities, memory bandwidth, battery life, etc.) to dynamically depict the user with the virtual look in real-time during a video call, and may be in communication with the server 105 to utilize the virtual cosmetics application 128 and/or AR module 144 to provide such functionality.

The memory 148 may store one or more computing modules 158 (e.g., the modules 138). The modules may include an I/O module 162 and an AR module 164 having the same and/or a similar configuration and/or functionality as the I/O module 142 and AR module 144 respectively.

The user device 115 may further include one or more sensors 170. In some embodiments, additional local and/or remote sensors 170 may be communicatively coupled to the user device 115. The sensors 170 may include any devices or components mentioned herein, other devices suitable for capturing data regarding the physical environment, and/or later-developed devices that may be configured to provide data regarding the physical environment (including components of structures or objects within the physical environment). Example sensors 170 of the user device 115 may include one or more accelerometers, gyroscopes, inertial measurement units (IMUs), GPS units, proximity sensors, image sensors (CMOS, infrared), cameras (single, stereoscopic), microphones, as well as any other suitable sensors. Additionally, other types of currently available or later-developed sensors may be included in some embodiments. One or more sensors 170 of the user device 115 may be configured for localization, head/movement tracking, geolocation, object recognition, computer vision, photography, positioning and/or spatial orientation, as well as other suitable purposes. The sensors 170 may provide sensor data regarding the user (e.g., characteristics of the user’s facial features) and/or the local physical environment which may be used to generate and/or present, overlay onto the user, and/or otherwise display the virtual cosmetics and/or virtual cosmetic looks, as described herein, among other things.

The user device 115 may include at least one user interface 172. The user interface 172 may include any suitable device(s) for receiving input, such as one or more of a microphone, a camera, a keyboard (hardware or virtual), a mouse, a capacitive touchscreen, etc. The user interface 172 may include any suitable device(s) for conveying output, such as one or more of a display (e.g., the display 154), a speaker, a touchscreen, a haptic motor, LEDs, etc. In some cases, the user interface 172 may be integrated into a single device, such as a touchscreen display (e.g., the display 154) that accepts user input and displays output. The user interface 172 may include one or more local interfaces, and/or may include one or more remote interfaces that are communicatively coupled to the user device 115 via the network 110.

The computing environment 100 may include and/or be communicatively coupled to at least one image capture device 175. The image capture device 175 may capture one or more images (e.g., static images, a real-time image stream) of its field of view. The image capture device 175 may include a webcam, a camera integrated into a laptop or other computing device, a smartphone, a smart device, a tablet, a laptop, a phablet, a wearable electronic or computing device, another type of personal computing device, a smart glass device, a smart watch device, a digital camera, or the like. The image capture device 175 may be included in, and/or communicatively coupled to, one or more components of the computing environment 100 (e.g. the user device 115, the server 105). Generally speaking, the image capture device 175 includes at least one of an image sensor (e.g., the sensors 170), a processor (e.g., the processor 120), and an imaging application, where the processor execute the imaging application to operate on data captured by the image sensor to generate one or more digital images and/or image streams (e.g., the real-time image stream).

In operation, the computing environment 100 may dynamically depict a user with a virtual cosmetic look during a video call or video conference. The virtual cosmetics may include one or more types of cosmetics (lip gloss, eye shadow, blush), colors of cosmetics, cosmetic finishes (e.g., glossy, matte), the application techniques of the virtual cosmetics (e.g., a light application, a thick application, contouring, highlighting), and/or any other suitable virtual cosmetic. Each virtual cosmetic may be associated with at least one facial feature of the user (e.g., virtual lipstick associated with user’s lips, virtual mascara associated with eyelashes, virtual eyeshadow associated with eyelids, etc.). One or more of the virtual cosmetics may create and/or comprise a virtual cosmetic look. The virtual cosmetic look may indicate or otherwise specify the particular application locations and/or particular application techniques of each virtual cosmetic included in the virtual cosmetic look. The virtual cosmetic look may be customized for and/or by the user, for example.

In some embodiments, the user device 115 may execute the virtual cosmetics client application 150 to depict the user with a virtual cosmetic look. It should be understood that although the virtual cosmetics client application 150 is generally described below, the virtual cosmetics application 128 may perform the same or similar functions, as previously described. The virtual cosmetics client application 150 may receive an indication of a virtual cosmetic look via the user interface 172 of the user device 115 and/or in any other suitable manner (e.g., based upon user preferences). In one example, the user may indicate the virtual cosmetic look by selecting individual cosmetics displayed at the user interface 172 by the virtual cosmetics client application 150. The indication may specify application locations (e.g., on associated facial features) of each virtual cosmetic and/or application techniques (e.g., lip overlining) of each virtual cosmetic. In another example, the user may choose previously selected and/or created virtual cosmetic looks via the user interface 172. In yet another example, the virtual cosmetics client application 150 may allow the user to search the virtual look data store 127 and/or a virtual cosmetic marketplace for the virtual cosmetic look. In still another example, the virtual cosmetics may be indicated based upon user preferences (e.g., a virtual cosmetic look that is automatically selected based upon preferences in a user profile), such as preferences indicating a selection of Halloween-themed virtual cosmetics during the end of October. In at least some embodiments, the virtual cosmetics client application 150 includes an offline mode which allows the user to design, customize, and/or save virtual cosmetic looks without needing an active communication channel connection. The virtual cosmetics client application 150 may obtain the virtual cosmetic look, such as from the memory 148, the virtual look data store 127 of the server 105 via the network 110, from a virtual cosmetic marketplace, from another user, and/or from any other suitable source of virtual cosmetic looks.

The virtual cosmetics client application 150 may determine, or otherwise have access to, characteristics of one or more facial features of the user’s face. The characteristics may include the type of facial feature (e.g., eye, nose, mouth, lip, cheek, forehead, etc.), color of the facial feature (e.g. eye color, skin tone of the cheek), skin type of the facial feature (e.g., dry skin, oily skin, porous skin, blotchy skin), dimensions of the facial feature (e.g., size, shape, curvature, position on the face), illumination of the facial feature (e.g., brightly lit, dimly lit, shadowy), and/or any other suitable facial feature characteristic. In some embodiments, determining characteristics of the user’s facial features may be based upon data based upon the real-time image stream (e.g., via analysis of the user’s face in the real-time image stream by the virtual cosmetics client application 150), from depth sensor data of one or more of depth sensors (e.g., the sensors 170, the image capture device 175) sensing the user’s facial characteristics (e.g., in real-time), from facial recognition, via facial biometrics, and/or in any other suitable manner. In at least some embodiments, the virtual cosmetics client application 150 may execute the first model 132 to determine the user’s facial characteristics, as the first model 132 may be trained to determine characteristics of the user’s facial features when receiving at least the real-time image stream as an input.

The virtual cosmetics client application 150 may overlay (e.g., via the AR module 144, 164) each virtual cosmetic of the virtual cosmetic look onto the associated facial feature(s) of the user depicted in a real-time image stream to thereby display the virtual cosmetic look on the face of the user depicted in the real-time image stream. In at least some embodiments, the user can preview the virtual cosmetic look on their face, for example via a graphical user interface provided by the virtual cosmetics client application 150. The virtual cosmetic look may be configured to the face of the user based upon the characteristics of the user’s facial features, user preferences, ML-based rendering techniques, etc. For example, as facial features differ from person, the virtual lipstick may be configured to each user so that it covers the entirety of their lips using their lip characteristics (e.g. the width, length, and curvature of the lips). The virtual cosmetic look may specify application locations (e.g., on the user’s face) and/or application techniques (e.g., a heavy application, a textured effect, a gradient effect, etc.).

The user device 115 may generate a real-time image stream (e.g., video) captured via an image sensor (e.g., a camera, one or more of the sensors 170, the image capture device 175). The virtual cosmetics client application 150 may cause the real-time image stream including the virtual cosmetics look overlay to be transmitted via a communication channel during a video call. The communication channel may be, and/or include, cellular, LAN, WAN, etc. In some embodiments, the virtual cosmetics client application 150 may provide the real-time video communication and/or video call. In other embodiments, the user device 115 may provide the real-time image stream via the operating system (e.g., as a native feature), a local or remote video communication application (e.g., Zoom®, Microsoft Team®, Apple FaceTime®) executed by the user device 115, and/or any other suitable provider, application and/or source. For example, the virtual cosmetics client application 150 may be in communication with (e.g., via a plug-in, an application programming interface (API)) with a web application using the real-time image stream during a video call.

The real-time image stream may include images of the user’s face and facial features, such as their entire face or a portion of the face (e.g., when not entirely in the field of view of the image sensor) with the overlay of the virtual cosmetic look. In at least some embodiments, the virtual cosmetics client application 150 may only overlay at least a portion of the virtual cosmetic look to the user when they are actively speaking or presenting during a video call, thereby saving bandwidth and other computing resources during such periods of inactivity. In at least some embodiments, the first model 132 may configure and/or display the virtual cosmetics/virtual cosmetic look on the face of the user in the real-time image stream based upon one or more of the characteristics of the one or more facial features of the user, the virtual cosmetic look, user preferences (e.g., from user customization of previous overlays of virtual cosmetic looks), etc. In some embodiments, responsive to a change in position of a facial feature of the user in the real-time image stream, the virtual cosmetics client application 150 causes (e.g., automatically and/or responsively causes) a corresponding change or other modification of the overlay of the virtual cosmetics on the facial feature that changed position. For example, if the user is wearing virtual eye shadow in the real-time image stream and tilts their head to the side, the overlay of the eye shadow moves along with the user’s eyes in real-time. The modifications to the virtual cosmetic look may include adjusting the position, shape, and/or luminosity of the eye shadow so it remains overlaid on the user’s eyes in the real-time image stream as the depiction of the eyes change position, shape and level of illumination as a result of the movement.

In response to a change in one or more characteristics of the communication channel of the video call, the virtual cosmetics client application 150 may modify the overlay of the virtual cosmetics look in the real-time image stream. The characteristics of the communication channel may be associated with one or more of stability of the communication channel (e.g., a brief drop in the connectivity), bandwidth of the communication channel (e.g., data throughput), speed of the communication channel (e.g., upload/download speed), latency of communication channel (delay in sending/receiving data), an amount of interference on the communication channel, and/or other suitable characteristic. The modification may be in response (e.g., automatically and/or dynamically in response) to the changes in the one or more characteristics of the communication channel exceeding a threshold. One or more of the thresholds may be set (e.g., by the second model 134, by the user via the virtual cosmetics client application 150), predefined (e.g., in the virtual cosmetics client application 150, based upon user preferences), and/or adjusted by the user. The thresholds may correspond to a desired level of consistency and/or quality (e.g., as defined by the user, the company, etc.). In one example, a degradation of one or more characteristics of the communication channel past a first threshold causes a reduction of a complexity of a representation, within the transmitted overlaid real-time image stream, of respective application locations and/or application techniques of one or more virtual cosmetics. In another example, an improvement of one or more characteristic of the communication channel past a second threshold causes an increase in the complexity of the representation, within the transmitted overlaid real-time image stream, of the respective application locations and/or application techniques of one or more virtual cosmetics. In yet another example, a degradation of one or more characteristics of the communication channel corresponding to a particular threshold causes a replacement of the depiction of the user within the real-time image stream with a static image of the user, or an avatar of the user. In at least some embodiments, a communication channel detection feature prioritizes the maintenance of critical features of the virtual cosmetic look during low-bandwidth situations, ensuring essential aspects of the look remain intact.

The virtual cosmetics client application 150 may conduct regular system and/or communication channel performance checks, predicting and informing users about potential communication channel issues based on historical data and current communication channel characteristics. The virtual cosmetics client application 150 may also include a feature for users to provide feedback on system performance under different communication channel conditions, which can be used for future system improvements and/or communication channel predictions.

In at least some embodiments, the second machine learning model 134 may predict one or more changes in one or more characteristics of the communication channel based on conditions associated with the communication channel. For example, the communication channel may be provided by a satellite communications network (e.g., Starlink®) connecting to the user’s in-home Wi-Fi network. Generally, after 3 pm on weekdays when the user’s three children return home from school, they play on-line games, stream videos, and connect their smartphones to the Wi-Fi network, all of which increases traffic of the Wi-Fi network that causes a decrease in available bandwidth on the Wi-Fi network. Moreover, when there is stormy weather the connection to the satellite network can degrade due to electromagnetic signal interference. For example, the conditions or otherwise characteristics associated with the communication channel include and/or indicate the network is a satellite network, the current weather is stormy, the time is 3:15 pm, the user device 115 is connected to the in-home Wi-Fi, and/or the Wi-Fi network traffic indicates multiple connected devices at least one of on a video call (e.g., indicated from data packet inspection). In such an example, the second ML model 134 may predict that during the video call, the bandwidth of the user’s Wi-Fi connection will substantially decrease, and the stability of the in-home connection to the satellite network may affected by the weather causing the communication channel to experience diminished speed and/or intermittent connectivity.

In at least some embodiments, based on the predictions of changes in the communication channel by the second ML model 134, the virtual cosmetics client application 150 may perform one or more actions. In one example, the virtual cosmetics client application 150 generate in advance a lower resolution of the user’s virtual cosmetic look used during the call, and load the virtual cosmetic look into local memory of the user device 115 so it may be quickly retrieved and overlaid on the user if the communication channel characteristics degrade. In another example, the virtual cosmetics client application 150 may generate a notification to the user before and/or during the video call suggesting the user connect their user device 115 to another communication channel if available, as the user may experience communication channel issues during the video call that may affect the overlay of the virtual cosmetics look.

In at least some embodiments, the change in one or more characteristics of the communication channel includes a degradation of the communication channel (e.g., a one or more connectivity outages, throttles speed, limited bandwidth, increase in latency, etc.). If the degradation exceeds a first threshold, a quality of one or more virtual cosmetics displayed in the real-time video communication may be reduced. For example, if the communication channel speed falls to less than 25 megabits/second (mb/s) during a video call, the virtual cosmetics client application 150 may render a virtual cosmetic at a lower resolution to decrease data transmitted and avoid the real-time image stream of the user with the virtual cosmetic from appearing pixelated, frozen, or other effects from the decrease in communication channel speed.

There may be multiple thresholds associated with the communication channel, each causing the virtual cosmetics client application 150 to perform an action corresponding to the threshold. For example, if the change in one or more characteristics of the communication channel improve beyond a second threshold (e.g., the speed increases from 25 mb/s to 50 mb/s), the virtual cosmetics client application 150 may improve the quality of the one or more virtual cosmetics in the real-time video communication (e.g., render the virtual cosmetics at a higher resolution, include advance shading techniques, etc.).

In some embodiments, responsive to a degradation of one or more characteristics of the communication channel exceeding a third threshold (e.g., falling below 5 mb/s) the virtual cosmetics client application 150 may replace the real-time image stream with a static image (e.g., an image of the user’s face with the user-selected virtual cosmetics applied, or a default virtual cosmetic look on the image, displayed during the video call rather than a real-time image of the user).

The virtual cosmetics client application 150 may provide via the user interface 172 functions and/or features associated with cosmetics/virtual cosmetics/virtual cosmetic looks. The features may include designing virtual cosmetic looks, editing virtual cosmetic looks, cosmetic advertisements, cosmetic reviews, cosmetic tutorials, user skin analysis (e.g., based upon the real-time image stream of the user or sensor data), providing communication (e.g., chat, messaging) with other users of the virtual cosmetics client application 150. The virtual cosmetics client application 150 may include a marketplace to purchase, share, sell, and/or create a wish list for, cosmetics and virtual cosmetic looks.

It should be understood that while the systems and methods generally disclose the virtual cosmetics for the face, the disclosed techniques may be used with virtual cosmetics, virtual bodily adornments (e.g., virtual tattoos, virtual jewelry, virtual eye color), and the like for other body parts of the user that may appear in the real-time image stream. For example, the computing environment 100 may be used to apply virtual nail polish to the user’s fingernails appearing in the real-time image stream, a virtual tattoo to the arm of a user appearing in the real-time image stream, and/or virtual blue irises to the user’s eye’s appearing in the real-time image stream.

It should be understood that, while the computing environment 100 is shown in FIG. 1 to include one each of the server 105, the network 110, the user device 115, and the image capture device 175, different numbers of servers 105, networks 110, user devices 115 and/or image capture devices 175 may be utilized. In one example, the computing environment 100 may include hundreds of servers 105 all of which may be interconnected via the network 110 to communicate with hundreds of user devices 115.

The computing environment 100 may include additional, fewer, and/or alternate components, and may be configured to perform additional, fewer, or alternate actions, including components/actions described herein. For example, although the server 105 is shown in FIG. 1 as including one instance of various components such as the processor 120, the memory 124 and the data store 126, various aspects include the computing environment 100 and/or the server 105 implementing any suitable number of any of the components shown in FIG. 1 and/or omitting any suitable ones of the components shown in FIG. 1. For instance, information described as being stored in the memory 124 may be stored in the data store 126, and therefore the memory 124 may be omitted. Furthermore, it should be appreciated that additional and/or alternative connections between components shown in FIG. 1 may be implemented. As just one example, the image capture device 175 may be connected to the user device 115 via a direct wired connection (e.g., a USB cable) rather than the network 110 as illustrated in FIG. 1.

### EXAMPLE ML MODEL TRAINING

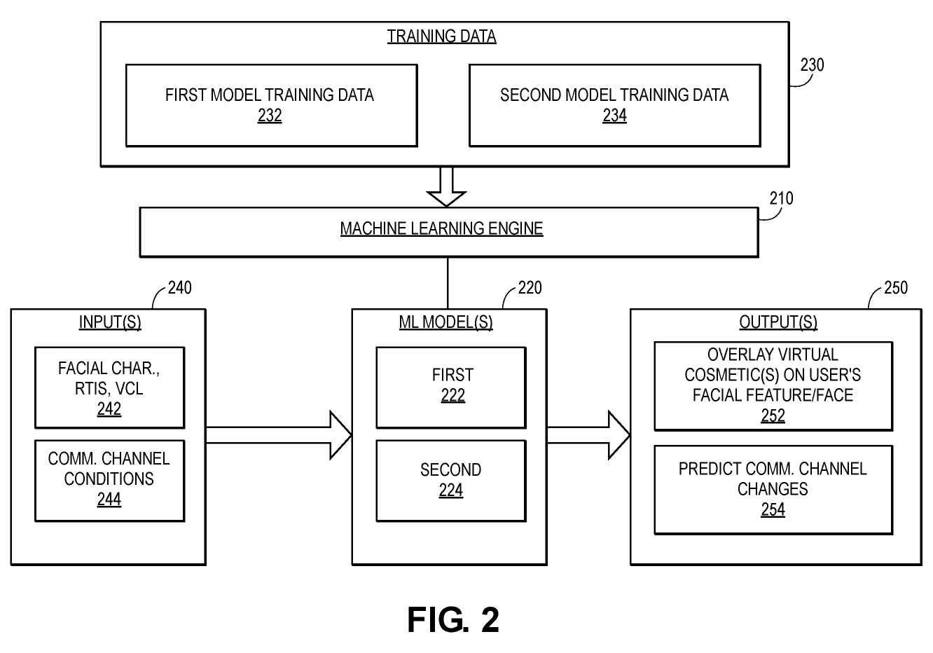

FIG. 2 depicts a combined block and logic diagram for training a machine learning models, according to some embodiments. More specifically, an ML engine 210 (e.g., the ML module 140) trains one or more ML models 220 (e.g., the ML models 130) using training data 230 (e.g., the training data 136). The trained ML models 220 may be applied to, and/or receive, at least one input 240 and generate at least one output 250.

The ML engine 210 may include one or more hardware and/or software components to obtain, create, (re)train, operate, fine-tune, and/or store the ML models 220. A server (e.g., the server 105), may obtain and/or have available (e.g., stored in the data store 126) one or more types of training data 230 for model creation, training, retraining and/or fine-tuning (generally referred to herein as “training”). In at least one aspect, at least some of the training data 230 may be labeled to aid in training the ML models 220. The ML engine 210 may process and/or analyze the training data 230 to learn associations and/or relationships in the training data 230, and configure the ML models 220 to process the training data 230 such that when the ML models 220 receive one or more inputs 240, they generate appropriate output(s) 250. The ML models 220 may be trained via regression, k-nearest neighbor, support vector regression, and/or random forest algorithms and/or models, although any type of applicable ML algorithm and/or training may be used, including training using one or more of supervised learning, unsupervised learning, semi-supervised learning, and/or reinforcement learning.

In at least one aspect, one or more of the ML models 220 may be considered as successfully trained when able to achieve one or more metrics (e.g., a score) associated with its performance when processing the training data 230. Once trained, the ML engine 210 may load one or more of the ML models 220 at runtime to perform operations on one or more data inputs 240 to produce the desired data output 250.

In at least some embodiments, the ML models 220 may include a first ML model 222 (e.g., the first model 132) trained to overlay the each virtual cosmetics in real-time onto the associated at least one facial feature and/or face of the user 252 in the real-time image stream as the output 250 based on receiving the real-time image stream (RTIS), the characteristics of the facial features of the user, and the virtual cosmetic look (VCL) of the user 242 as the input 240.

The training data 230 may include first model training data 232 for training the first ML model 222. The first model training data 232 may include historical characteristics of facial features of historical users, historical virtual cosmetic looks including one or more historical virtual cosmetics, and historical overlays of the historical virtual cosmetics on the facial features of the historical users for the historical virtual cosmetic looks, and/or any other suitable first model training data 232. The historical facial features may include the type of facial feature (e.g., eye, nose, mouth, lip, cheek, forehead, etc.), color of the facial feature (e.g. eye color, skin tone of the cheek), skin type of the facial feature (e.g., dry skin, oily skin, porous skin, blotchy skin), dimensions of the facial feature (e.g., size, shape, position of the face), or illumination of the facial feature (e.g., brightly lit, dimly lit, shadowy), and/or any other suitable historical characteristics of facial features.

The first ML model 222 may be trained using the first model training data 232 to make associations between the historical characteristics of historical facial features of the face of the historical users and historical overlays of historical virtual cosmetics associated with the historical facial features onto the historical facial features of the face of the historical users for historical virtual cosmetic looks displayed in historical real-time image streams, and optionally to determine respective strengths of such associations. In one example, the first ML model 222 may learn associations between facial feature dimensions and the size and shape of the virtual cosmetics associated with that facial feature, such that when virtual cosmetics are overlaid in the real-time image stream onto the face of the user having features with certain dimensions, the virtual cosmetics may provide full coverage of the associated facial feature(s). In one example, the first ML model 222 may learn associations between the user’s skin tone and skin type, and level of shading, depth of color, reflectiveness, shadowing, and contrast of virtual cosmetics, such that when the virtual cosmetics are overlaid onto the face of the user having certain a lighter skin tones, the virtual cosmetics appear photorealistic and natural looking on the use. The first ML model 222 may learn any other suitable associations from the first model training data 232.

In at least some embodiments, the ML models 220 may include a second ML model 224 (e.g., the second model 134) trained to predict the change in one or more characteristics of the communication channel 254 as the output 250 based on receiving one or more characteristics/conditions associated with the communication channel 244 as the input 240. The training data 230 may include second model training data 234 for training the second ML model 224. The second model training data 234 may include historical characteristics associated with historical communication channels (e.g., characteristics associated with any stage of the communication channel itself, characteristics of the network providing the communication channel, characteristics associated with network equipment, characteristics associated with network equipment, etc.) and/or any other suitable second model training data 234.

The second ML model 224 may be trained using the second model training data 234 to determine associations between the historical changes of one or more characteristics of the historical communication channels and the historical characteristics of the historical communication channels, and optionally to determine respective strengths of such associations. For example, the second model 224 may learn associations between the signal to noise ratio of the communication channel and connectivity disruptions, such that when the signal to noise ratio is within a certain range the second ML model 224 may predict communication channel connectivity issues. In another example, the second ML model 224 may learn associations between the number of connected devices to a certain model of Wi-Fi router, and available bandwidth, such that when a threshold number of users are connected to the Wi-Fi router the second ML model 224 may make predict a decrease in bandwidth of the communication channel.

The server, the ML engine 210, and/or other suitable device may update the training data 230 at one or more times. The ML models 220 may be retrained based upon the updated training data 230, the retrained/updated ML models 220 may be stored in memory, and subsequently executed to generate improved outputs based upon the retraining. This process may cause the output 250 of the ML models 220 to improve over time. For example, the first ML model 222 may overlay a virtual cosmetic look onto the face of the user, and the user may make adjustments to the overlay of the virtual cosmetic look via the virtual cosmetics application 128 In at least some embodiments, the user change may be stored as user preferences (e.g., in a user profile accessible to the virtual cosmetics application 128. The server and/or ML engine 210 may store (in the memory 124 or the data store 126) as updated first model training data 232 the characteristics of the user’s facial features input to the first ML model 222 and data associated with the overlay of the virtual cosmetics on the face of the user 252 after the user adjustments are made (e.g., the position, size, shape, color, shading, etc. after the adjustments). The ML engine 210 may train the first ML model 222 using the updated training data, such that when the first ML model 222 receives the same or similar facial feature characteristics as the user as the input 240, it may provide an improved overlay of the virtual cosmetics on the face of the user 252 as the output 250.

### EXAMPLE DYNAMIC DEPICTION OF A USER WITH VIRTUAL COSMETICS

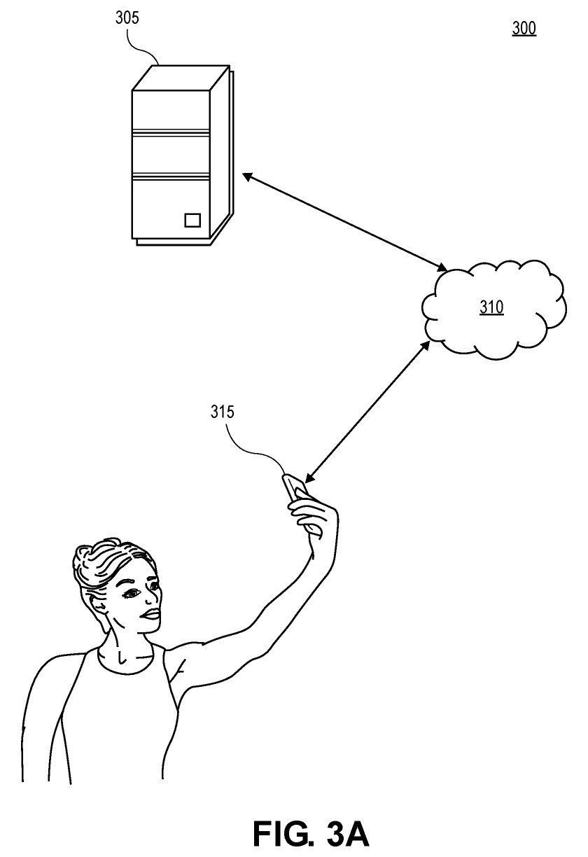

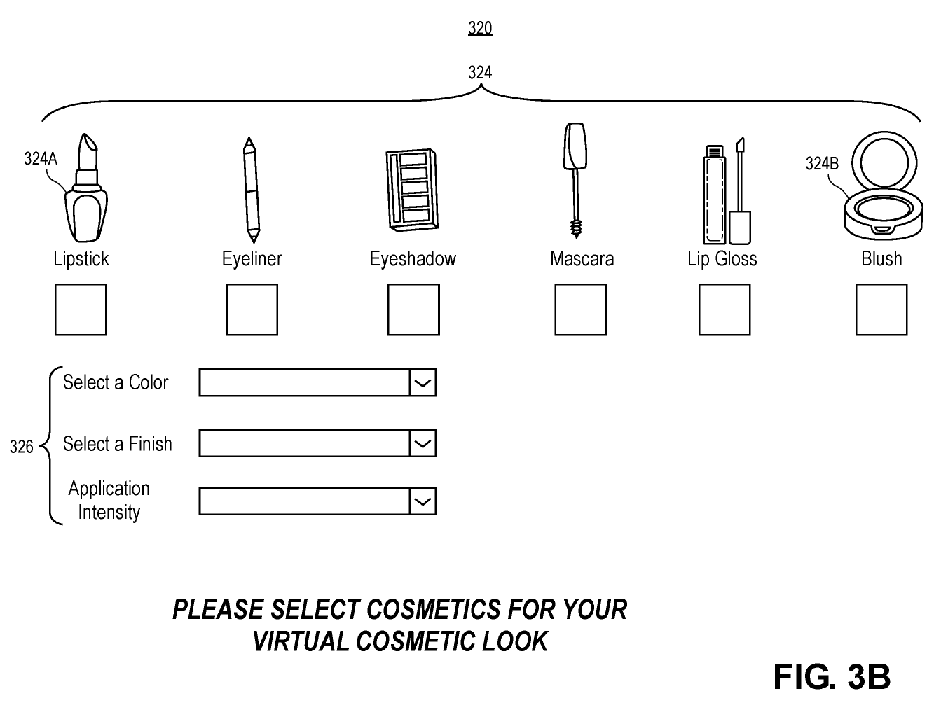

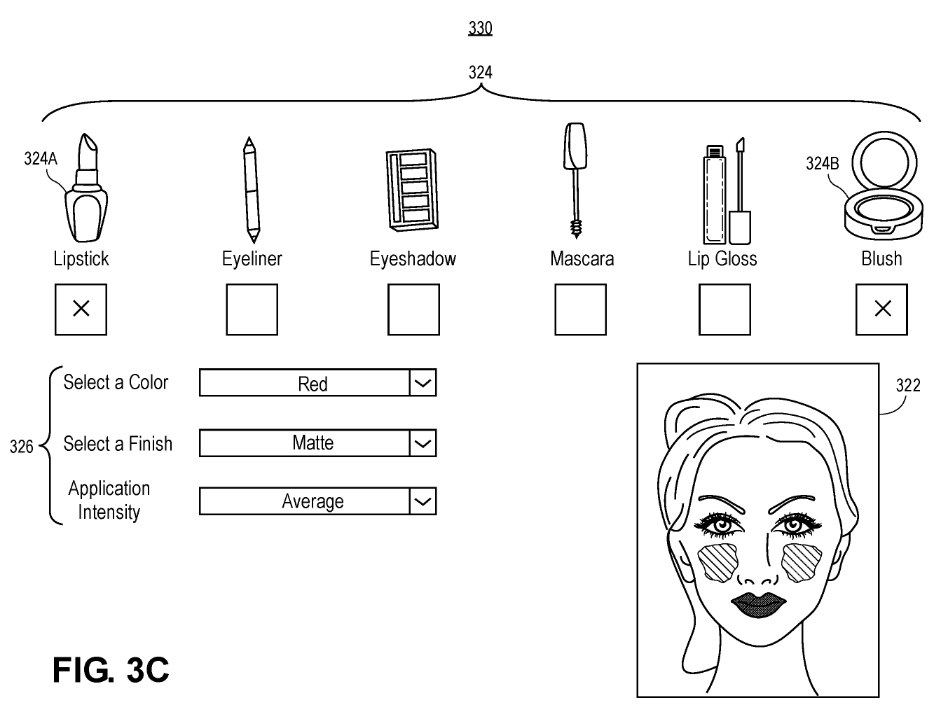

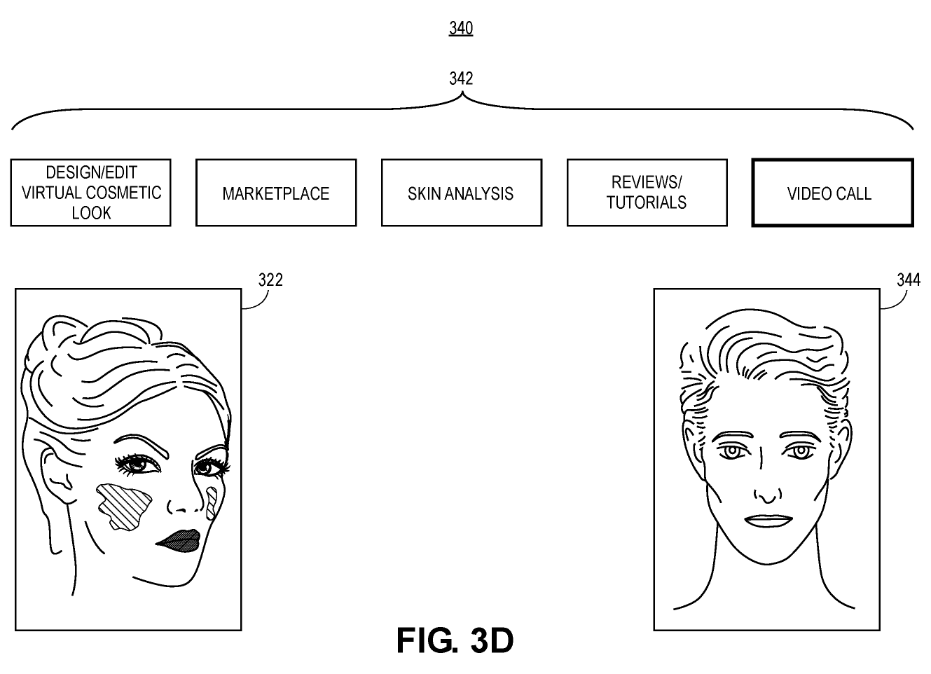

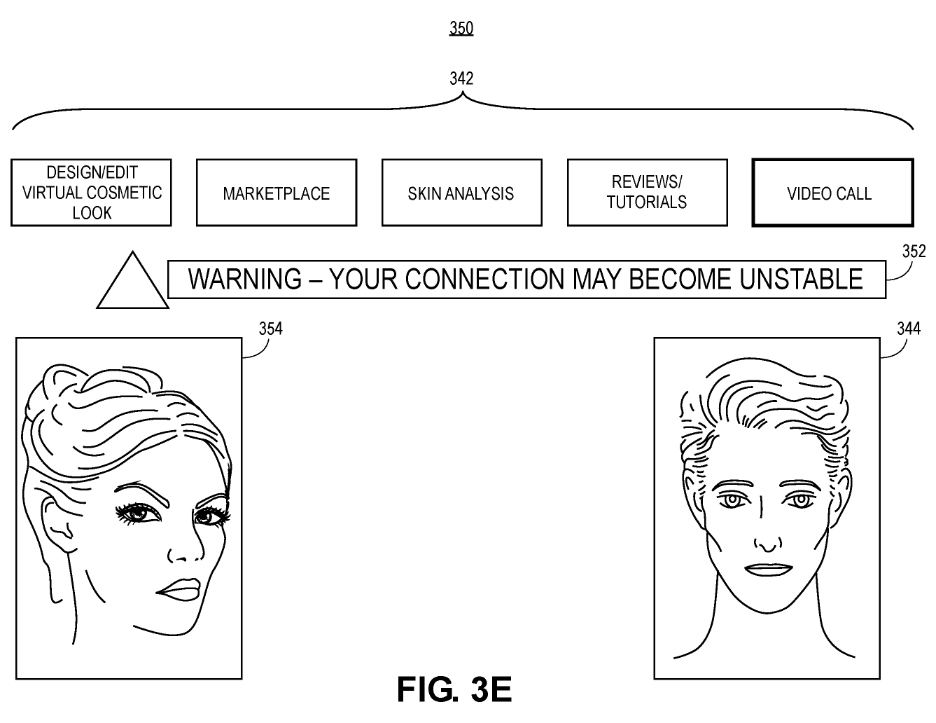

FIG. 3A depicts an example system 300 for dynamically depicting a user with virtual cosmetics during a video call, according to some embodiments. The system 300 includes a server 305 (e.g., the server 105) communicatively coupled via a network 310 (e.g., the network 110) to a smartphone 315 (e.g., the user device 115). It should be understood that system 300 may include additional, fewer, and/or alternate components such as the components described herein, and may be configured to perform additional, fewer, or alternate actions, including actions described herein.

A user Alex executes a virtual cosmetics mobile application (e.g., the virtual cosmetics client application 150) downloaded on their smartphone 315. The virtual cosmetics mobile application (“app”) may receive, via a touchscreen display (e.g., the user interface 172, the display 154), an indication of one or more virtual cosmetics. FIG. 3B depicts an example first user interface 320 to receive the indication of virtual cosmetics from Alex, according to some embodiments. The virtual cosmetics mobile application generates the first user interface 320, and provides the first user interface 320 on the touchscreen of the smartphone 315. The first user interface 320 displays virtual cosmetic icons 324, and virtual cosmetic options 326. Alex is able to select one or more of the virtual cosmetics via the virtual cosmetic icons 324 to create their virtual cosmetic look. Alex indicates their selection of a virtual lipstick by tapping on the virtual lipstick icon 324A, and a virtual blush by tapping on the virtual blush icon 324B of the first user interface 320. The first user interface 320 also allows Alex to indicate via the virtual cosmetic options 326 the virtual lipstick in red with a matte finish with average application intensity, and the virtual blush in pink with average application intensity. In response to Alex’s virtual cosmetic selections, the virtual cosmetics mobile application retrieves a virtual lipstick model and a virtual blush model from a virtual cosmetics library (e.g., the virtual look data store 127) of a database (e.g., the data store 126) of the server 305.

The virtual cosmetics mobile application activates a camera (e.g., the sensors 170) and a combination infrared projector/detector sensor (e.g., the sensors 170) of the smartphone 315. The camera is configured to capture a real-time image stream of Alex that is displayed within the user interface of the virtual cosmetics mobile application. The infrared projector/detector (IPD) sensor is configured to project infrared dots onto Alex’s face, and determine characteristics of Alex’s face based upon detecting the infrared dots, such as the size, spatial relationships, and contours of features of Alex’s face. The virtual cosmetics mobile application analyzes the real-time image stream to determine the dimensions of Alex’s facial features, the color of their skin tone, and the illumination levels of Alex’s facial features. In other embodiments, the characteristics of Alex’s face may be stored (e.g., in a user profile on the memory 148 from past usage of the virtual cosmetics mobile application) and/or otherwise available to the virtual cosmetics mobile application, which may eliminate the need for determining the characteristics of their face.

The smartphone 315 includes an AR module (e.g., the AR module 144, 164) which the virtual cosmetics mobile application executes to perform customization of the virtual lipstick model and the virtual blush model. The virtual lipstick model and the virtual blush model are customized to and/or based upon, the characteristics Alex’s lips and cheeks. The AR module may further customize the virtual models to match the cosmetic options 326 Alex selects, as well as any other customizations (e.g., based upon Alex’s user preferences). The customized virtual lipstick model and customized virtual blush model may be referred to hereinafter as a virtual lipstick and a virtual blush respectively.

In at least some embodiments, the virtual cosmetics mobile application may present representations of one or more virtual cosmetics/virtual cosmetic looks via the first user interface 320 so Alex may select existing virtual cosmetics/virtual cosmetic looks rather than having to indicate new virtual cosmetics/virtual cosmetic looks. In such embodiments, the virtual cosmetics mobile application may retrieve the already-created virtual cosmetic looks (e.g., from the memory 148, the data store 126) rather than generate new virtual cosmetic looks using the AR module.

FIG. 3C depicts an example second user interface 330 generated by the virtual cosmetics mobile application depicting Alex with virtual cosmetics, according to some embodiments. The real-time image stream 322 depicts Alex’s face with the overlay of the virtual lipstick and virtual blush on their lips and cheeks respectively. The virtual cosmetics mobile application may allow Alex to customize one or more of the virtual cosmetics (e.g., in real-time) as they appear in the real-time image stream via the cosmetic options 326 and/or other suitable function. For example, Alex may change the color of the virtual lipstick if she does not enjoy the way the red virtual lipstick appears in the real-time image stream. Alex may make other customizations and/or edits not shown in the cosmetic options 326. For example, Alex may prefer virtual lipstick that is applied outside the boundary of their lips to make their lips appear fuller. The AR module may initially overlay the virtual lipstick within the borders of Alex’s lips, and Alex may adjust the overlay to extend the virtual lipstick beyond the border of their lips. In at least some embodiments, the virtual cosmetics mobile application may learn (e.g., via the first model 132, 222) Alex’s preferences and/or store such preferences in a user profile for Alex, such that future overlays of virtual lipsticks extend beyond the border of their lips.

FIG. 3D depicts an example third user interface 340 generated by the virtual cosmetics mobile application dynamically depicting Alex with virtual cosmetics during a video call with a video call participant 344, according to some embodiments. The third user interface 340 provides various functions 342 of the virtual cosmetics mobile application including, but may not be limited to, designing and/or editing a virtual cosmetic look, accessing a virtual marketplace for cosmetics and virtual cosmetics, performing a skin analysis, cosmetic reviews and tutorials, and conducting a video call.

The virtual marketplace for cosmetics and virtual cosmetics may include one or more of: subscription services (e.g., cometic looks, products, and virtual cosmetics mobile application features), purchasing/selling/trading/gifting/licensing cosmetics/virtual cosmetics/virtual cosmetic looks, product information, product recommendations, product usage instructions, estimated delivery timelines, shipping costs, advertising (e.g., businesses, brands, influencers; personalized promotional content for cosmetic/virtual cosmetic products, brands, and trends, based on user preferences and usage patterns), wishlists, social and interactive shopping, communication with other users. Performing a skin analysis may include suggesting cosmetics/virtual cosmetics/virtual cosmetic looks based on the user's skin condition and type.

Alex selects the function for conducting the video call, and in response the virtual cosmetics mobile application causes the overlaid real-time image stream 322 to be transmitted, via a communication channel, during a video call. For example, a video call that is transmitted by the smartphone 315 over a cellular communication channel of the network 310.

During the video call, the depiction of Alex in the real-time image stream 322 may change in real-time as Alex moves in real-time, and/or as other changes captured by the real-time image stream 322 (e.g., change in lighting levels) occur in real-time. For example, as Alex speaks or smiles during the video call, their lips and their cheeks will move in the real-time image stream 322. The virtual cosmetic look may also change in real-time to continue to appear realistic and/or correctly applied to Alex’s face. In at least some embodiments, the virtual cosmetics mobile application may include and/or be communicability coupled to a first ML model (e.g., the first model 132, 222) to perform the overlay of the virtual cosmetic look onto Alex’s face in real-time.

Rendering, altering, and/or otherwise providing the overlay of the virtual cosmetic look in real-time may involve complex operations and/or require specific computing resources capable of providing the real-time overlay of the virtual cosmetic look. The smartphone 315 may have limited computing resources not capable of providing the real-time overlay, and the virtual cosmetics mobile application may offload tasks associated with providing overlaying the virtual cosmetic look on Alex’s face to the server 305 which may be configured for such tasks. For example, the server 305 may include an AR module (e.g., the AR module 144) and/or a first ML model (e.g., the first model 132, 222) that can perform for users of multiple computing devices AR-associated tasks such as overlaying virtual cosmetic looks in real-time on the user in the real-time image stream 322. In such examples, the virtual cosmetics mobile application via the smartphone 315 may transmit Alex’s facial characteristics data, the virtual cosmetics models of the virtual cosmetic look, and the real-time image stream 322 over the network 310 to the server 305. The server 305 may provide Alex’s facial characteristics data, the virtual cosmetics models of the virtual cosmetic look, and the real-time image stream 322 to the first ML model as an input, and the first ML model may overlay the virtual cosmetic look customized to Alex’s face in real-time in the real-time image stream 322 as an output. The server 305 may provide the real-time overlay to the virtual cosmetics mobile application (e.g., via an API) for display during the video call.

Returning to FIG. 3D, the user interface 340 depicts Alex with their head turned in one direction, which is a different depiction of Alex compared to the real-time image stream 322 of the user interface 330 which depicts Alex looking straight ahead. Although Alex’s face is changed in direction, the virtual lipstick remains overlaid on their lips, and the virtual blush remains overlaid on their cheek, such that the overlay of the virtual cosmetic look on Alex’s face is adjusted in real-time in correspondence with their movements. The real-time overlay of the virtual cosmetic look may include other changes as well, such as changing to contract and shading of the virtual cosmetics of the virtual cosmetic look based upon a change in illumination of Alex’s face once turned, and/or any other suitable changes to the virtual cosmetics/virtual cosmetic look.

One or more conditions or otherwise characteristics of the communication channel may affect the real-time overlay the virtual cosmetic look on Alex’s face in the real-time image stream 322. For example, if the cellular communication channel degrades (e.g., bandwidth decreases, throughput decreases, speed decreases) during the video call, the display of the virtual cosmetic look on Alex’s face may be adjusted in real-time. In at least some embodiments, if one or more characteristics of the communication channel degrade past a first threshold, the virtual cosmetics mobile application may reduce one or more qualities of one or more virtual cosmetics overlaid on Alex’s face in the real-time image stream 322 of the video call. For example, at the start of the video call, the communication channel may be carried over a 5G cellular connection supporting 75 mb/s for which the virtual cosmetic look overlaid on Alex’s face is rendered at high definition resolution with a 256-color palette, and shadowing techniques that provide the illusion of depth of the virtual cosmetic look on Alex’s face. During the video call, the cellular connection may degrade to 4G LTE cellular connection supporting 20 mb/s causing the overlay of the virtual cosmetic look to be rendered at standard resolution with a 16-color palette, and no shadowing techniques.

Conversely, if the change in the communication channel includes an improvement of the communication channel exceeding a second threshold, the display of the virtual cosmetic look overlaid on Alex’s face in the real-time image stream 322 may include improving the one or more qualities of the virtual cosmetic look. For example, if during the video call the cellular connection improves to a 5G ultrawideband (UWB) cellular connection supporting 150 mb/s, the virtual cosmetic look overlaid on Alex’s face may rendered at ultra-high definition resolution with a 1,024-color palette, with shadowing, anti-aliasing and motion-blur techniques that provide a three-dimensional, photorealistic appearance of the virtual cosmetic look on Alex’s face.

In at least some embodiments, if the communication channel degrades past a third threshold associated with one or more characteristics of the communication channel, the virtual cosmetics mobile application may replace the real-time image stream with a static image. For example, if the cellular connection degrades to 3G cellular connection supporting 5 mb/s, the real-time image stream 322 of Alex may be replaced with an image, such as an image previously captured from the real-time image stream 322, an image uploaded by Alex, and/or any other suitable image.

In at least some embodiments, the virtual cosmetics mobile application may include, and/or be communicatively coupled to, a second ML model (e.g., the second ML model 134, 224) to predict the change in the communication channel based on conditions associated with the communication channel. The virtual cosmetics mobile application and/or other applications, device, services, etc., may monitor conditions associated with the communication channel. Data associated with conditions of the communication channel may be provided to the second ML model as an input, and the second ML model to make the predictions regarding the communication channel changes. In such embodiments, based upon the predicted change(s) in the communication channel, the virtual cosmetics mobile application may automatically adjust the display of the virtual cosmetic look overlay based upon the predicted change(s) in the communication channel, provide a warning to the user, store the conditions of the communication channel and associated predictions as model training data to retrain the second ML model, and/or other suitable action.

FIG. 3E depicts an example fourth user interface 350 generated by the virtual cosmetics mobile application depicting a user with virtual cosmetics during a video call over a degraded communication channel, according to some embodiments. The fourth user interface 350 includes a warning 352 associated with a prediction of the second ML model based upon the cellular communication channel degrading beyond a third threshold. The fourth user interface 350 also replaces the real-time image stream 322 of Alex with a static picture 354 of Alex based upon the degraded communication channel conditions.

### EXAMPLE COMPUTER-IMPLEMENTED METHOD FOR DYNAMICALLY DEPICTING A USER WITH VIRTUAL COSMETICS DURING A VIDEO CALL

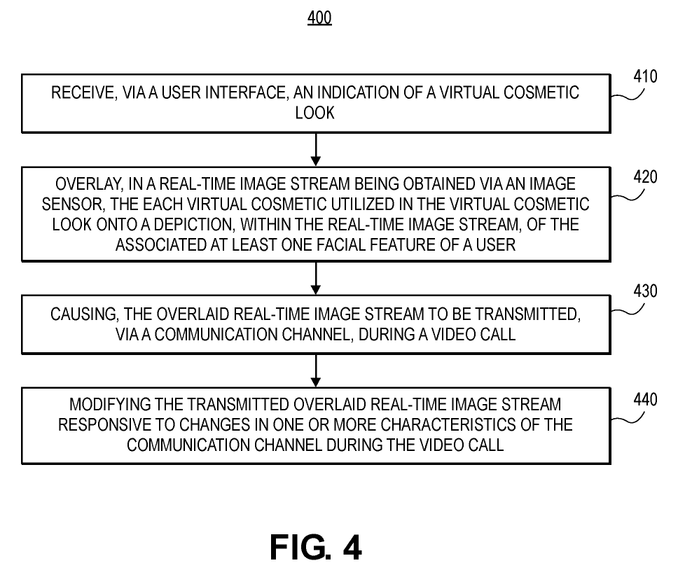

FIG. 4 is a flow diagram depicting an example computer-implemented method 400 for dynamically depicting a user with virtual cosmetics during a video call, according to some embodiments. In general, the computer-implemented method 400 may be performed by the devices, models, and/or other components of the computing environment 100 and/or the system 300. One or more steps of the computer-implemented method 400 may be implemented as a set of instructions stored on a computer-readable memory and executable by one or more processors (e.g., the processor 120, 146).

The computer-implemented method 400 may include receiving, by one or more processors via a user interface (e.g., the user interface 172), an indication of a virtual cosmetic look (block 410). The virtual cosmetic look may specify respective application locations and application techniques of each virtual cosmetic included in a set of virtual cosmetics to generate the virtual cosmetic look. Each virtual cosmetic of the set of virtual cosmetics may be associated with at least one facial feature of the user. The set of virtual cosmetics corresponding to the virtual cosmetic look may include multiple virtual cosmetics. The virtual cosmetic look may be obtained from the virtual look data store 127. The virtual cosmetic look may be customized for the user based upon preferences of the user.

The computer-implemented method 400 may include overlaying, by the one or more processors in a real-time image stream being obtained via an image sensor (e.g., the sensors 170, the image capture device 175), the each virtual cosmetic utilized in the virtual cosmetic look onto a depiction, within the real-time image stream, of the associated at least one facial feature of a user (block 420). The overlay may be in accordance with one or more characteristics of the at least one facial feature of the user and with the virtual cosmetic look. The facial feature characteristics may include at least one of: a type of a facial feature, a color of the facial feature, a skin type of the facial feature, one or more dimensions of the facial feature, or a level of illumination of the facial feature. In at least some embodiments computer-implemented method 400 may include determining, by the one or more processors, the characteristics of the facial features of the user based upon one or more of: the real-time image stream, depth sensor data, or facial recognition of the user.

The computer-implemented method 400 may include causing, by the one or more processors, the overlaid real-time image stream to be transmitted, via a communication channel, during a video call (block 430).

The computer-implemented method 400 may include modifying, by the one or more processors, the transmitted overlaid real-time image stream responsive to changes in one or more characteristics of the communication channel during the video call (block 440). The one or more characteristics of the communication channel include at least one of: a stability of the communication channel, a bandwidth of the communication channel, a speed of the communication channel, an amount of interference on the communication channel, or a latency of the communication channel.

In at least some embodiments of the computer-implemented method 400, the changes in the one or more characteristics of the communication channel may include a degradation of a characteristic of the communication channel past a first threshold, and the modification to the transmitted overlaid real-time image stream may include a reduction of a complexity of a representation, within the transmitted overlaid real-time image stream, of respective application locations and/or application techniques of one or more virtual cosmetics included in the set of virtual cosmetics specified by the virtual cosmetic look.

In at least some embodiments of the computer-implemented method 400, the changes in the one or more characteristics of the communication channel may include an improvement to the characteristic of the communication channel past a second threshold, and the modification to the transmitted overlaid real-time image stream may include an increase in the complexity of the representation, within the transmitted overlaid real-time image stream, of the respective application locations and/or application techniques of the one or more virtual cosmetics included in the set of virtual cosmetics specified by the virtual cosmetic look.

In at least some embodiments, the computer-implemented method 400 may include, responsive to a degradation of a characteristic of the communication channel corresponding to a particular threshold, replacing, by the one or more processors, a depiction of the user within the real-time image stream with at least one of a static image of the user or an avatar of the user.

In at least some embodiments, the computer-implemented method 400 may include modifying, by the one or more processors, the overlay corresponding to the virtual cosmetic look and the user responsive to at least one of: movements of the user depicted within the real-time image stream or changes in lighting depicted within the real-time image stream

In at least some embodiments, the computer-implemented method 400 may include a first machine learning model (e.g., the first model 132) stored on the one or more non-transitory memories (e.g., the memory 124, the data store 126). The first machine learning model may be trained using first model training data to determine associations between historical characteristics of historical facial features of respective faces of historical users and historical overlays of historical virtual cosmetics on the historical facial features of the respective faces of the historical users corresponding to historical virtual cometic looks. The first machine learning model may overlay the each virtual cosmetic of the set of virtual cosmetics utilized in the virtual cosmetic look onto the associated at least one facial feature of the user depicted in the real-time image stream in accordance with the one or more characteristics of the at least one facial feature of the user and with the virtual cosmetic look.

In at least some embodiments, the computer-implemented method 400 may include a second machine learning model (e.g., the second model 134) stored on the one or more non-transitory memories (e.g., the memory 124, the data store 126). The second machine learning model may be trained using second machine learning model training data to determine associations between historical changes of the historical communication channels and historical conditions of the historical communication channels. The second model may predict the change in the communication channel based upon one or more conditions and/or characteristics associated with the communication channel.

It should be understood that not all blocks of the example flow diagram of FIG. 4 are required to be performed. Additionally, the computer-implemented method 400 may include fewer, additional, and/or other steps than those depicted in FIG. 4.

### Additional Considerations

This detailed description is to be construed as an example only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as an example only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as an example only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A system for dynamically depicting users with virtual cosmetic looks during video calls, the system comprising:
one or more processors; and
one or more non-transitory memories coupled to the one or more processors storing computer-executable instructions stored on the one or more non-transitory memories that, when executed by the one or more processors, cause the system to:
receive, via a user interface, an indication of a virtual cosmetic look, the virtual cosmetic look specifying respective application locations and application techniques of each virtual cosmetic included in a set of virtual cosmetics to generate the virtual cosmetic look, and the each virtual cosmetic of the set of virtual cosmetics associated with at least one facial feature;
overlay, in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look;
cause the overlaid real-time image stream to be transmitted, via a communication channel, during a video call; and
modify the transmitted overlaid real-time image stream responsive to changes in one or more characteristics of the communication channel during the video call.

2. The system of claim 1, wherein the set of virtual cosmetics corresponding to the virtual cosmetic look includes multiple virtual cosmetics.

3. The system of claim 1, wherein the one or more characteristics of the communication channel include at least one of: a stability of the communication channel, a bandwidth of the communication channel, a speed of the communication channel, an amount of interference on the communication channel, or a latency of the communication channel.

4. The system of claim 1, wherein at least one of:
(i) the changes in the one or more characteristics of the communication channel include a degradation of a characteristic of the communication channel past a first threshold, and the modification to the transmitted overlaid real-time image stream includes a reduction of a complexity of a representation, within the transmitted overlaid real-time image stream, of respective application locations and/or application techniques of one or more virtual cosmetics included in the set of virtual cosmetics specified by the virtual cosmetic look; or
(ii) the changes in the one or more characteristics of the communication channel include an improvement to the characteristic of the communication channel past a second threshold, and the modification to the transmitted overlaid real-time image stream includes an increase in the complexity of the representation, within the transmitted overlaid real-time image stream, of the respective application locations and/or application techniques of the one or more virtual cosmetics included in the set of virtual cosmetics specified by the virtual cosmetic look.

5. The system of claim 1, further comprising additional computer-executable instructions that, when executed by the one or more processors, cause the system to:
responsive to a degradation of a characteristic of the communication channel corresponding to a particular threshold, replace a depiction of the user within the real-time image stream with at least one of a static image of the user or an avatar of the user.

6. The system of claim 1, further comprising additional computer-executable instructions that, when executed by the one or more processors, cause the system to:
modify the overlay corresponding to the virtual cosmetic look and the user responsive to at least one of: movements of the user depicted within the real-time image stream or changes in lighting depicted within the real-time image stream.

7. The system of claim 1, wherein the one or more characteristics of the at least one facial feature of the user include at least one of: a type of a facial feature, a color of the facial feature, a skin type of the facial feature, one or more dimensions of the facial feature, or a level of illumination of the facial feature.

8. The system of claim 1, further comprising additional computer-executable instructions that, when executed by the one or more processors, cause the system to:
determine the one or more characteristics of the at least one facial feature of the user based upon one or more of: the real-time image stream, depth sensor data, or facial recognition of the user.

9. The system of claim 1, further comprising:
a machine learning model stored on the one or more non-transitory memories, the machine learning model trained using model training data to determine associations between historical characteristics of historical facial features of respective faces of historical users and historical overlays of historical virtual cosmetics on the historical facial features of the respective faces of the historical users corresponding to historical virtual cometic looks; and
wherein the system utilizes the machine learning model to overlay the each virtual cosmetic of the set of virtual cosmetics utilized in the virtual cosmetic look onto the associated at least one facial feature of the user depicted in the real-time image stream in accordance with the one or more characteristics of the at least one facial feature of the user and with the virtual cosmetic look.

10. The system of claim 1, further comprising a virtual look data store, and wherein the virtual cosmetic look is obtained from the virtual look data store.

11. The system of claim 1, wherein the virtual cosmetic look is customized for the user based upon preferences of the user.

12. A computer-implemented method for dynamically depicting users with virtual cosmetic looks during video calls, the computer-implemented method comprising:
receiving, by one or more processors via a user interface, an indication of a virtual cosmetic look, the virtual cosmetic look specifying respective application locations and application techniques of each virtual cosmetic included in a set of virtual cosmetics to generate the virtual cosmetic look, and the each virtual cosmetic of the set of virtual cosmetics associated with at least one facial feature;
overlaying, by the one or more processors in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look;
causing, by the one or more processors, the overlaid real-time image stream to be transmitted, via a communication channel, during a video call; and
modifying, by the one or more processors, the transmitted overlaid real-time image stream responsive to changes in one or more characteristics of the communication channel during the video call.

13. The computer-implemented method of claim 12, wherein the one or more characteristics of the communication channel include at least one of: a stability of the communication channel, a bandwidth of the communication channel, a speed of the communication channel, an amount of interference on the communication channel, or a latency of the communication channel.

14. The computer-implemented method of claim 12, wherein at least one of:
(i) the changes in the one or more characteristics of the communication channel include a degradation of a characteristic of the communication channel past a first threshold, and the modification to the transmitted overlaid real-time image stream includes a reduction of a complexity of a representation, within the transmitted overlaid real-time image stream, of respective application locations and/or application techniques of one or more virtual cosmetics included in the set of virtual cosmetics specified by the virtual cosmetic look; or
(ii) the changes in the one or more characteristics of the communication channel include an improvement to the characteristic of the communication channel past a second threshold, and the modification to the transmitted overlaid real-time image stream includes an increase in the complexity of the representation, within the transmitted overlaid real-time image stream, of the respective application locations and/or application techniques of the one or more virtual cosmetics included in the set of virtual cosmetics specified by the virtual cosmetic look.

15. The computer-implemented method of claim 12, further comprising:
responsive to a degradation of a characteristic of the communication channel corresponding to a particular threshold, replacing, by the one or more processors, a depiction of the user within the real-time image stream with at least one of a static image of the user or an avatar of the user.

16. The computer-implemented method of claim 12, further comprising:
modifying, by the one or more processors, the overlay corresponding to the virtual cosmetic look and the user responsive to at least one of: movements of the user depicted within the real-time image stream or changes in lighting depicted within the real-time image stream.

17. The computer-implemented method of claim 12, wherein the one or more characteristics of the at least one facial feature of the user include at least one of: a type of a facial feature, a color of the facial feature, a skin type of the facial feature, one or more dimensions of the facial feature, or a level of illumination of the facial feature.

18. The computer-implemented method of claim 12, further comprising:
determining, by the one or more processors, the one or more characteristics of the at least one facial feature of the user based upon one or more of: the real-time image stream, depth sensor data, or facial recognition of the user.

19. The computer-implemented method of claim 12, further comprising:
a machine learning model trained using model training data to determine associations between historical characteristics of historical facial features of respective faces of historical users and historical overlays of historical virtual cosmetics on the historical facial features of the respective faces of the historical users corresponding to historical virtual cometic looks,
wherein the machine learning model overlays the each virtual cosmetic of the set of virtual cosmetics utilized in the virtual cosmetic look onto the associated at least one facial feature of the user depicted in the real-time image stream in accordance with the one or more characteristics of the at least one facial feature of the user and with the virtual cosmetic look.

20. A non-transitory computer readable medium having computer-executable instructions stored thereon that, when executed by one or more processors, cause the one or more processors to:
receive, via a user interface, an indication of a virtual cosmetic look, the virtual cosmetic look specifying respective application locations and application techniques of each virtual cosmetic included in a set of virtual cosmetics to generate the virtual cosmetic look, and the each virtual cosmetic of the set of virtual cosmetics associated with at least one facial feature;
overlay, in a real-time image stream being obtained via an image sensor, the each virtual cosmetic utilized in the virtual cosmetic look onto a depiction, within the real-time image stream, of the associated at least one facial feature of a user, the overlay in accordance with one or more characteristics of the at least one facial feature of the user and with the virtual cosmetic look;
cause the overlaid real-time image stream to be transmitted, via a communication channel, during a video call; and
modify the transmitted overlaid real-time image stream responsive to changes in one or more characteristics of the communication channel during the video call.
